(19) United States
(12) Patent Application Publication
(10) Pub. No.: US 2002/0123369 A1
(43) Pub. Date: Sep. 5, 2002

(54) Portable telephone

(76) Inventor: Masayoshi Morimoto, Tokyo (JP)

Correspondence Address: REED SMITH HAZEL & THOMAS LLP, Suite 1400, 3110 Fairview Park Drive, Falls Church, VA, 22042, US

(21) Appl. No.: 09/796,791

(22) Filed: Mar. 2, 2001

(51) Int. Cl. H04M 1/00

(52) U.S. Cl. 455/558; 455/406

(57) ABSTRACT

Disclosed is a portable telephone using a prepaid card. The prepaid card is provided very cheaply or at not charge to the user by automatically providing the user with not only the inherent function of making a telephone call but also information such as product information for PR, the details of a product, company information, and the address of the company's home page on the Internet for sales promotion of products. This portable telephone includes: a portable telephone body; a reading section provided for the body, for reading a remaining given value and various information images stored in a prepaid card; a display for displaying the read information; and means for outputting the read information by sound.

### BACKGROUND OF THE INVENTION

1. Field of the Invention

The present invention relates to a portable telephone and, more particularly, to an improvement in a portable telephone using a prepaid card.

2. Related Background Art

In association with recent development and widespread use of the portable telephone technique, various functions have come to be provided. One of examples of the functions is use of a prepaid card in a portable telephone. The function has been achieved in order to avoid excessive use of a telephone by allowing telephone calls of the given amount of a prepaid card to be made.

### SUMMARY OF THE INVENTION

The invention is directed to a provide a portable telephone using a prepaid card which is provided very cheaply or at not charge to the user by automatically providing the user with not only the inherent function of making a telephone call but also information such as product information for PR, the details of a product, company information, and the address of the company's home page on the Internet for sales promotion of products.

The invention is characterized in that a portable telephone body has a reading section for reading a prepaid card. On the surface of the prepaid card, various information images are printed. In the prepaid card, not only a remaining given value but also various information images are stored in an information area. After the information area of the prepaid card is inserted to the reading section of the portable telephone body and the information is read by the reading section, the read information is outputted by sound or on the display of the telephone body for a few seconds to a few minutes.

That is, the prepaid card is usually provided by a company very cheaply or at no charge to the user and, in return, PR of a product of the company and the like is outputted by sound or displayed on the display of the portable telephone body for a few seconds to a few minutes, thereby making a sales promotion.

The reading section for reading the prepaid card may be constructed by a reading unit such as a bar code scanner for optically reading information, and an optical sensor for converting a light image formed via an optical device into an electric signal and outputting the electric signal.

In an embodiment of the invention, it is preferable to provide means for displaying, for example, only what is called a banner of a company providing the prepaid card when the user makes calls successively or makes calls repeatedly to the same number.

### BRIEF DESCRIPTION OF THE DRAWINGS

FIG. 1 is a perspective view of a portable telephone body;

FIG. 2 is a perspective view of a prepaid card; and

FIG. 3 is a flowchart showing operations of the portable telephone according to an embodiment of the invention.

### DETAILED DESCRIPTION OF THE PREFERRED EMBODIMENT

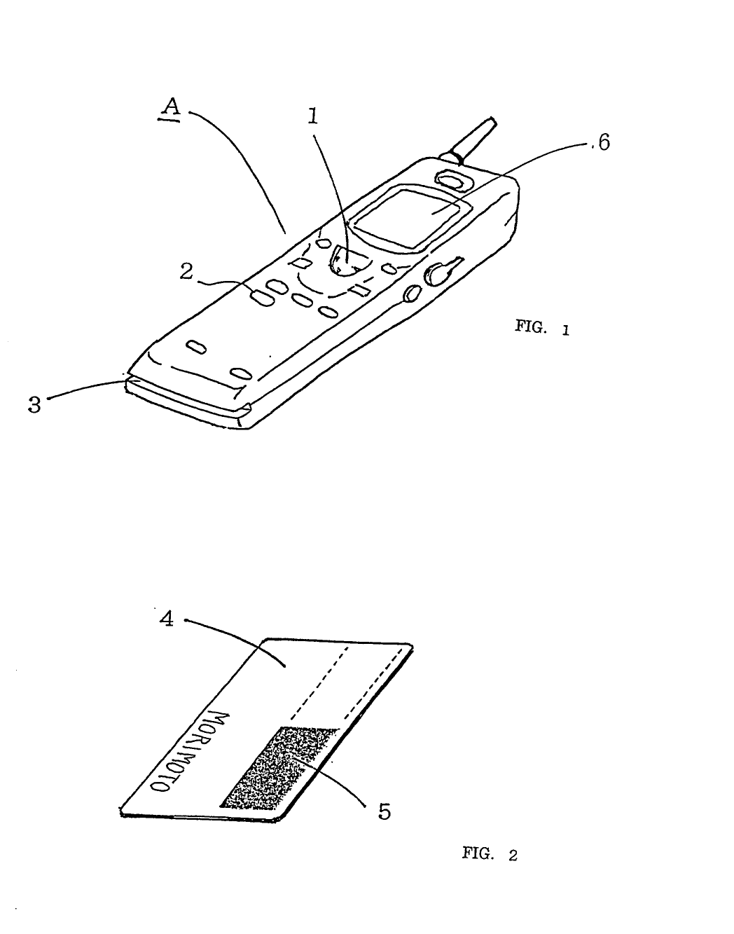

FIG. 1 shows a known portable telephone body A. On the surface of the portable telephone body A, a selection button 1 for various functions and push button digits 2 are disposed. In the embodiment of the invention, a reading section 3 for reading a prepaid card, which is open at an end of the portable telephone body A is provided.

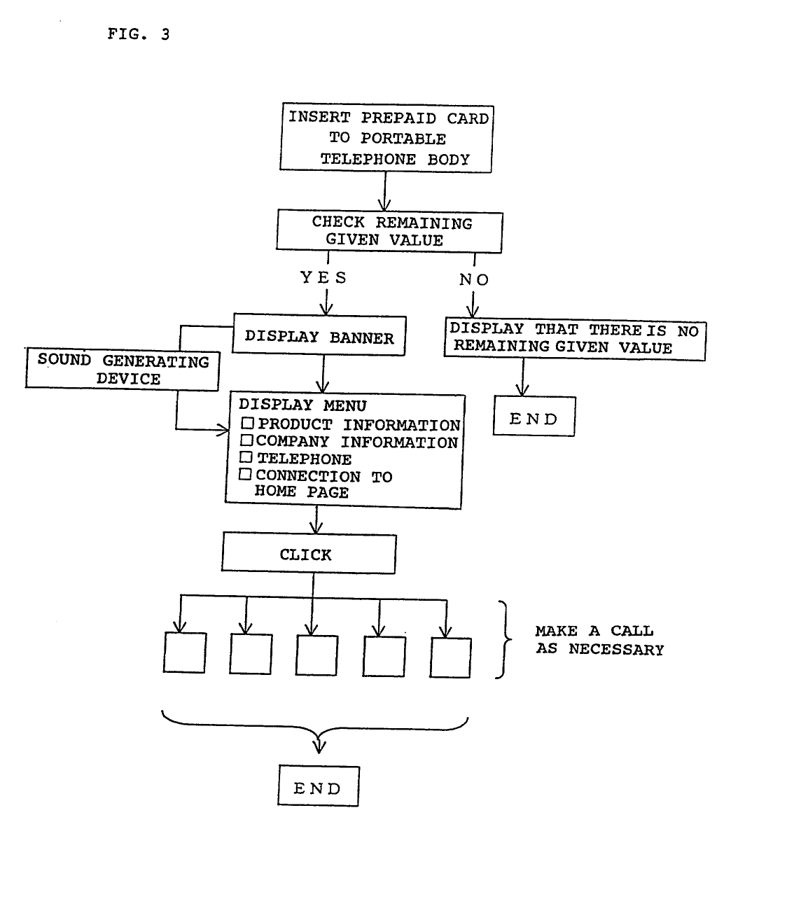

Reference numeral 4 in FIG. 2 denotes a prepaid card which has, on its top face, an information area 5 in which at least the remaining given value of the card 4, product information and company information of a company providing the prepaid card 4, an address of the company's home page, and the like is stored.

By sliding the prepaid card 4 in the horizontal direction so that the information area 5 is passed through the reading section 3, the information of the information area 5 is read.

The mechanism of the reading section 3 is not limited to read storage information magnetically in an ordinary manner. Although not specifically shown and described here, in order to read a bar code or a recently-developed image of a drawing, a character, and a figure, a known photoreceiving sensor may be provided for the reading section 3 to convert a light image formed via an optical device into an electric signal, and to display an image on a display 6 of the portable telephone body A by the electric signal.

The prepaid card 4 is provided, for example, at no charge from a company (sponsor) attempting to sell products. The user who received the prepaid card 4 passes the information area 5 through the reading section 3 of the portable telephone body A. The reading section 3 first retrieves the remaining given value. When there is no given value left, the message indicative of the fact is displayed on the display 6 of the portable telephone body A and the operation is finished.

When there is a remaining given value in the prepaid card 4, the reading section 3 of the portable telephone body A recognizes it and displays a banner of the sponsor company on the display 6. The banner is preferably simple, clear characters or figure of a few seconds to one or two minutes, which arouses a desire of the user (purchaser) for the product.

Subsequently, the reading section 3 displays

product information,

company information,

address of a company's home page,

telephone,

and the like on a display 6 when the prepaid card is inserted for the first time or after a relatively long time since the last use date which is stored by operating means (not shown).

This arrangement is made to eliminate the inconvenience that the banner and the above are always displayed, which might bother the user when the portable telephone is often used. It is also possible to always display a very short banner or display the banner only once.

When the user (purchaser) wants to know the details of the product displayed on the prepaid card 4, by clicking the “product” on the display 6 by operating the function button 1, the details of the product are displayed. It is preferably to arrange in such a manner that, when the user wishes to visit the company's home page, by connecting the portable telephone to a personal computer, the portable telephone is automatically connected to the company's home page on the Internet.

When “telephone” on the display 6 is clicked, obviously, an ordinary telephone call can be made by using the push button digits 2.

As described above, according to the invention, a prepaid card is provided by a company usually at no charge and, in return, at least a banner of a product of the company as the provider of the prepaid card is shown to the user when the prepaid card is used, thereby arousing customer interest. In such a manner, a PR effect is displayed. The user (purchaser) can make a call corresponding to a predetermined given value at no charge.

What is claimed is:

1. A portable telephone comprising:
a portable telephone body;
a reading section provided for said body, for reading a remaining given value stored in a prepaid card and various information images stored in the prepaid card;
a display for displaying the read information; and
means for outputting the read information by sound,
wherein the information stored in the prepaid card is outputted by sound or on the display at least for a few seconds or a few minutes after reading said prepaid card by said portable telephone body and, after that, an ordinary call can be made.

2. A portable telephone according to claim 1, wherein the information images are optically readable, and the reading section comprises a reading unit for optically reading the information images, and an optical sensor for converting a light image formed via an optical device into an electric signal and outputting the electric signal.

3. A portable telephone according to claim 1, wherein at least information of a provider of the prepaid card and information of an address of a provider's home page on the Internet is stored in the prepaid card, the information of the provider and the address of the provider's home page is displayed for a few seconds or a few minutes after reading the prepaid card, and a connection to the home page can be made by a simple clicking operation.
